(19) United States
(12) Patent Application Publication
(10) Pub. No.: US 2005/0019114 A1
(43) Pub. Date: Jan. 27, 2005

(54) Nanodiamond PCD and methods of forming

(76) Inventor: Chien-Min Sung, Tansui (TW)

Correspondence Address: M. Wayne Western;THORPE NORTH & WESTERN, LLP, P.O. Box 1219, Sandy, UT, 84091-1219, US

(21) Appl. No.: 10/627,442

(22) Filed: Jul. 25, 2003

(51) Int. Cl. B23P 15/28

(52) U.S. Cl. 407/119; 51/307

(57) ABSTRACT

A nanodiamond tool, including a mass of sintered nanodiamond particles can be produced having improved mechanical, thermal, and electrical properties. The sintered mass can contain greater than about 95% by volume nanodiamond and greater than about 98% by volume carbon. Such nanodiamond tools can be formed by assembling a mass of nanodiamond particles and sintering the mass of nanodiamond particles to form a sintered mass. Prior to sintering, the mass of nanodiamond particles can be substantially free of non-carbon materials such as metal binders, sintering aids or the like. Upon sintering, the nanodiamond particles sinter together at high pressures and lower temperatures than those typically required in producing polycrystalline diamond compacts with diamond crystals of a larger size. The absence of non-carbon materials improves the high temperature performance and reliability of the nanodiamond tools of the present invention.

### FIELD OF THE INVENTION

The present invention relates generally to diamond tools and methods for producing diamond tools. Accordingly, the present application involves the fields of physics, chemistry, and material science.

### BACKGROUND OF THE INVENTION

Polycrystalline diamond (PCD) is used extensively in the superabrasive industry for the production of cutting tools, drill bits, wire drawing dies, dressers, and a wide variety of other tools. The basic process of forming PCD was developed in the 1960's and has become a fundamental process in the superabrasive industry. Typical PCD is formed by loading a mold with small diamond grains, e.g, often from 2 to 25 μm. The mold is commonly a refractory metal cup made of Ti, Ta, Zr, W, or other metal or metal alloys. A metal substrate, typically cobalt cemented tungsten carbide, is placed adjacent to the diamond grains and the entire assembly is subjected to high pressure. Heat is then applied sufficient to melt the cobalt and allow the cobalt to flow into the interstitial pores of the diamond grains. At these high pressures and temperatures, the cobalt, or other carbide forming infiltrant, acts as a sintering aid to sinter adjacent diamond particles together. The diamond becomes more soluble in the infiltrant at higher pressures. The final product can contain diamond-to-diamond bridges with the infiltrating alloy occupying a small volume, typically a few volume percent. The diamond content of such infiltrated PCD is typically in excess of 80% by volume, whereas a similar non-infiltrated pressed diamond compact results in a diamond content of around 65% by volume. These non-infiltrated compacts involve primarily mechanical bonding of particles and lack the requisite strength for most mechanical applications.

However, in order to provide sufficient porosity to allow the infiltrant to flow throughout the diamond grains, the diamond grain particle sizes are typically in excess of about 1 μm. Further, most common infiltrants, such as cobalt, also act as a catalyst for converting diamond to graphite at ambient pressures and temperatures above about 700° C. Thus, care must be taken so as not to exceed such temperatures during use of the PCD tool to prevent degradation of the diamond. A variety of methods has attempted to overcome this difficulty with moderate success. However, these methods also tend to increase production costs and manufacturing complexity. As such, methods capable of producing diamond tools capable of high temperature performance and improved properties continue to be sought through ongoing research and development efforts.

### SUMMARY OF THE INVENTION

Accordingly, the present invention provides materials and methods for producing tools and devices having improved high temperature performance. In one aspect of the present invention, a nanodiamond tool having a mass of sintered nanodiamond particles is formed. In a detailed aspect, the mass of sintered nanodiamond particles can contain greater than about 95% by volume nanodiamond and greater than about 98% by volume carbon.

In accordance with the present invention, the nanodiamond particles of the nanodiamond tools can be self-sintered. Alternatively, the nanodiamond particles can include in situ grown nanocrystalline diamond. The in situ grown nanocrystalline diamond can be grown from a carbon source such as fullerenes. Typically, the in situ grown nanocrystalline diamond can constitute less than about 50% by volume of the mass of sintered nanodiamond particles. In one aspect, the mass of sintered nanodiamond particles of the present invention may be predominantly nanodiamond or nanocrystalline material and is substantially free of non-carbon constituents. In another aspect of the present invention, the mass of sintered nanodiamond consists of carbon constituents.

A variety of nanodiamond particles can be suitable for use in the present invention. In one aspect, the nanodiamond particles have an average diameter of from about 1 nm to about 500 μm. In another aspect, the nanodiamond particles have an average diameter of from about 1 nm to about 100 nm, and are frequently from about 2 nm to about 30 nm. Regardless of the particle size the nanodiamond particles of the present invention can have an average crystal size of from about 1 nm to about 20 nm. In accordance with the present invention, the nanodiamond particles are randomly oriented within the mass of sintered nanodiamond particles. Particularly, the individual nanocrystalline crystals of the present invention can be randomly oriented.

For many commercial applications, the mass of sintered nanodiamond particles of the present invention can be attached to a substrate The substrate can be chosen to act as a mechanical support for the sintered nanodiamond or to provide other benefits such as decreased manufacturing costs, providing a surface which can be incorporated into a final tool or product, or to impart specific thermal or electrical properties to the final tool. Substrates can be formed and/or attached simultaneously with the sintering of the nanodiamond particles. Alternatively, the substrate can be attached to the mass of sintered nanodiamond particles by methods such as brazing, gluing, and the like.

In yet another aspect of the present invention, the substrate includes a layer of at least micron-sized diamond bonded to the mass of nanodiamond particles A support layer can also be bonded to the layer of at least micron-sized diamond. Typically, the layer of at least micron-sized diamond can be bonded by a metal binder. The at least micron-sized diamond particles can have an average particle size of from about 0.1 μm to about 100 μm. Metal binders suitable for use in the present invention can include nickel, iron, cobalt, manganese, and mixtures or alloys thereof. Whenever a substrate is used in connection with the nanodiamond of the present invention, the substrate can include materials such as, but not limited to, tungsten, titanium, cemented tungsten carbide, cermets, ceramics, and composites or alloys thereof.

In accordance with the present invention, a wide variety of tools and devices can advantageously utilize the mass of sintered nanodiamond particles. Nanodiamond tools such as cutting tools, drill bits, dressers, polishers, bearing surfaces, and wire drawing dies can be formed in accordance with the principles of the present invention Alternatively, the nanodiamond tool can be a heat spreader. Such heat spreaders can have thermal conductivities which approach and exceed that of pure diamond Similarly, the nanodiamond tool can be incorporated into other electronic devices such as surface acoustic wave (SAW) filters. In yet another aspect of the present invention, the nanodiamond tool can be a radiation window. The mass of sintered nanodiamond particles of the present invention can be permeable to certain wavelengths of energy thus allowing monitoring or application of energy in an otherwise closed environment.

In accordance with the present invention, nanodiamond tools can be formed by assembling a mass of nanodiamond particles and then sintering the mass of nanodiamond particles to form a sintered mass In one aspect, the sintered mass can contain greater than about 95% by volume nanodiamond particles and greater than about 98% by volume carbon. In another aspect, the mass of nanodiamond particles can include substantially only nanodiamond particles up to the step of sintering Accordingly, upon sintering the nanodiamond particles become self-sintered.

In an alternative method in accordance with the present invention, the step of assembling a mass of nanodiamond particles includes mixing a fullerene carbon source with the nanodiamond particles to form a mixture. The fullerene carbon source can occupy less than about 50% by volume of the mixture of nanodiamond particles and carbon source. In one aspect, after sintering, the sintered mass contains greater than about 99% by volume nanodiamond particles.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A shows a side cross-sectional view of one embodiment of a precursor assembly in accordance with the present invention.

FIG. 1B shows a side cross-sectional view of assembly of FIG. 1A after sintering and removal from the HPHT apparatus.

FIG. 2A shows a side cross-sectional view of one alternative embodiment of a precursor assembly in accordance with the present invention.

FIG. 2B shows a side cross-sectional view of assembly of FIG. 2A after sintering and removal from the HPHT apparatus, bonded to a substrate

FIG. 3A shows a side cross-sectional view of another alternative embodiment of a precursor assembly in accordance with the present invention.

FIG. 3B shows a side cross-sectional view of assembly of FIG. 3A after sintering and removal from the HPHT apparatus.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a diamond particle” includes one or more of such particles, reference to “the layer” includes reference to one or more of such layers, and reference to “an infiltrant” includes reference to one or more of such techniques.

Definitions

In describing and claiming the present invention, the following terminology will be used in accordance with the definitions set forth below.

As used herein, “diamond” refers to a crystalline structure of carbon atoms bonded to other carbon atoms in a lattice of tetrahedral coordination known as sp³ bonding and includes amorphous diamond. Specifically, each carbon atom is surrounded by and bonded to four other carbon atoms, each located on the tip of a regular tetrahedron. The structure and nature of diamond, including its physical and electrical properties are well known in the art.

As used herein, “amorphous diamond” and “diamond-like-carbon” may be used interchangeably and refer to a material having carbon atoms as the majority element, with a substantial amount of such carbon atoms bonded in distorted tetrahedral coordination. As used herein, “distorted tetrahedral coordination” refers to a tetrahedral bonding configuration of carbon atoms that is irregular, or has deviated from the normal tetrahedron configuration of diamond as described above. Such distortion generally results in lengthening of some bonds and shortening of others, as well as the variation of the bond angles between the bonds. Additionally, the distortion of the tetrahedron alters the characteristics and properties of the carbon to effectively lie between the characteristics of carbon bonded in sp³ configuration (i.e. diamond) and carbon bonded in sp² configuration (i.e. graphite). One example of material having carbon atoms bonded in distorted tetrahedral bonding is amorphous diamond. A variety of other elements can be included in the carbonaceous material as either impurities, or as dopants, including without limitation, hydrogen, sulfur, phosphorous, boron, nitrogen, silicon, tungsten, etc. Nanodiamond particles may have amorphous diamond structure along the outer edges, which may be more stable at these small dimensions.

As used herein, “nanodiamond” refers to diamond particles having crystal sizes in the nanometer range, i.e. about 1 nm to about 100 nm and preferably from about 1 nm to about 20 nm. Nanodiamond particles can also have nanometer range crystalline formations, e.g., about 1 nm to about 10 nm. Further, nanodiamond is intended to refer to diamond having nanometer scale crystal structure. Thus, the term “nanodiamond” can include diamonds having a particle size in the micrometer range or larger, as long as such particles have crystal sizes within the nanometer range specified above. For example, current technologies involve two methods of producing nanodiamond suitable for use in the present invention, although nanodiamond particles produced by other methods can be used. One method involves the explosion of dynamite to produce nanodiamond having nanocrystalline structure and has particle sizes in the range of from about 2 to about 10 nm. A second method involves exposing graphite to a shockwave at nearly instantaneous high temperature and high pressure. The nanodiamond particles produced using this shockwave method typically has nanocrystalline structure and micron particle sizes from about 10 μm to about 500 μm.

As used herein, “crystal” is to be distinguished from “particle”. Specifically, a crystal refers to a structure in which the repeated or orderly arrangement of atoms in a crystal lattice extends uninterrupted, although minor defects may be present. Many crystalline solids are composed of a collection of multiple crystals or grains. A particle can be formed of a single crystal or from multiple crystals as individual crystals grow sufficient that adjacent crystals impinge on one another to form grain boundaries between crystals. Each crystal within the polycrystalline particle can have a random orientation.

As used herein, “micron-sized diamond” refers to diamond particles having crystal sizes greater than those of nanodiamond. Thus, although some nanodiamond can have particle sizes in the micrometer range, these are not considered micron-sized diamond in the present disclosure. Further, the term “at least micron-sized diamond” is used to refer to any diamond particles having crystal sizes greater than those of nanodiamond, regardless of the particle size. As such, at least micron-sized diamond can range in crystal size from about 0.1 μm to several millimeters, although typical sizes range from about 0.1 μm to about 500 μm.

As used herein, “self-sintered” refers to particles which sinter together without the use of a secondary material. Thus, for example, nanodiamond particles can sinter together to form a substantially continuous network of diamond without the use of typical infiltrants or sintering aids. Further, self-sintering indicates that the nanodiamond particles are sintered without an additional carbon source, such as fullerenes, graphite, or the like.

As used herein, “substantial” when used in reference to a quantity or amount of a material, or a specific characteristic thereof, refers to an amount that is sufficient to provide an effect that the material or characteristic was intended to provide. Therefore, “substantially free” when used in reference to a quantity or amount of a material, or a specific characteristic thereof, refers to the absence of the material or characteristic, or to the presence of the material or characteristic in an amount that is insufficient to impart a measurable effect, normally imparted by such material or characteristic.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 micrometers to about 5 micrometers” should be interpreted to include not only the explicitly recited values of about 1 micron to about 5 microns, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value. Furthermore, such an interpretation should apply regardless of the breadth of the range or the characteristics being described.

The Invention

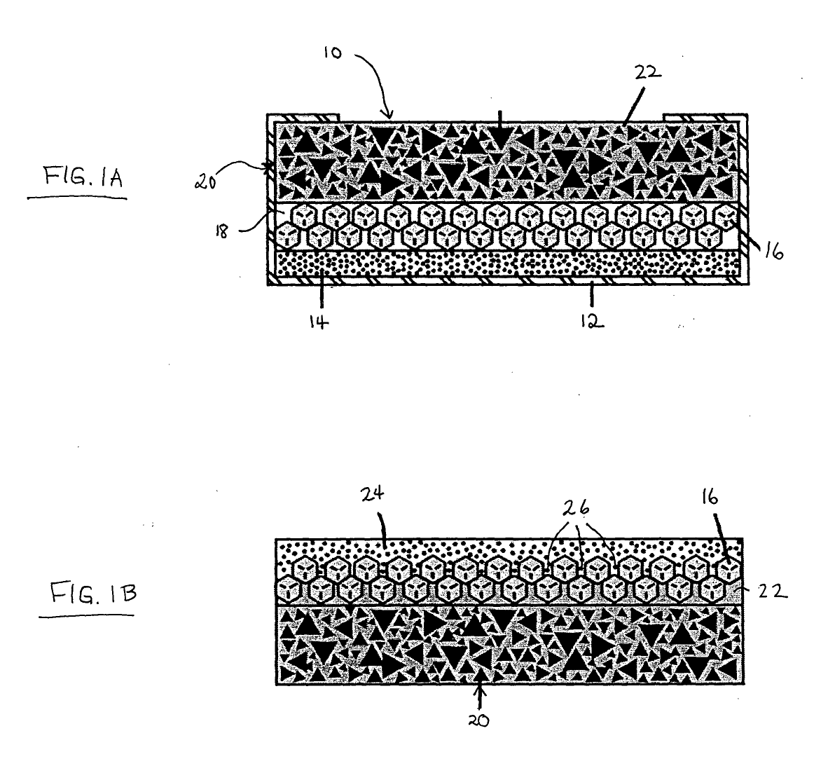

Referring now to FIG. 1A, a precursor assembly is shown generally at 10, in accordance with one embodiment of the present invention. The precursor assembly 10 is placed in a mold 12. The mold shown is a refractory metal cup suitable for use in a conventional HPHT apparatus; however, it will be understood that the principles of the present invention also apply to any process capable of achieving the necessary pressures and temperatures as discussed below. The mold typically comprises a refractory metal such as tantalum, titanium, zirconium, tungsten, or the like.

In accordance with one aspect of the present invention, a mass of nanodiamond particles 14 is assembled and placed in the mold 12. The nanodiamond particles can have an average diameter of from about 1 nm to about 500 μm, such as from about 1 nm to about 100 nm. In a preferred embodiment, the nanodiamond particles can have an average diameter of from about 2 nm to about 30 nm. In one detailed aspect, the nanodiamond particles can have an average crystal size of from about 1 nm to about20 nm. Additionally, the mass of diamond particles may consist of nanodiamond. Although trace amounts of various materials can be present, typically no other materials need be added to the mass of nanodiamond particles. The mass of nanodiamond particles can be formed in almost any shape. A wide variety of thicknesses can also be used, and the mass of nanodiamond particles of the present invention is not limited in dimensions.

By contrast, typical cobalt sintered PCD greater than 1 to 2 mm requires some care to prevent uneven sintering and reduced product quality. The absence of such sintering aids in the present invention makes such concerns largely irrelevant. The size of the sintered nanodiamond of the present invention is primarily limited by the available equipment and apparatus. Typical PCD thicknesses can vary depending on the intended final tool, but are often from about 10 μm to about 5 mm. The final sintered mass will have a thickness which, of course, will be slightly thinner than the pre-sintered thickness. Those skilled in the art are well acquainted with taking these changes in dimension into account in designing appropriate molds, although the very low porosity among nanodiamond particles results in a lesser degree of dimensional changes during sintering than traditional diamond PCD.

Once placed in the mold, the mass of nanodiamond particles can then be sintered to form a sintered mass. The sintering process of the present invention can occur at a temperature of from about 1,300° C. to about 2,500° C. and a pressure of from 1 GPa to about 6 GPa. As the pressure is increased, lower temperatures are required to achieve sintering. For mechanical applications, lower temperatures, thus higher pressures, are preferred in order to minimize grain growth. Conversely, grain growth may be desirable if the final tool is to be used as a heat spreader or other similar product which does not require high mechanical strength. Thus, any pressure can be used, provided it is sufficient to prevent the conversion of diamond to graphite. In one aspect, the final sintered mass can contain greater than about 95% by volume nanodiamond particles. Further, the final sintered mass can have greater than about 98% by volume carbon, and can exceed 99% by volume.

In one embodiment of the present invention, the assembled mass of nanodiamond particles may consist essentially of nanodiamond particles up to the step of sintering. Upon sintering, the individual nanodiamond particles sinter together without the use of a secondary material and are self-sintered. In another detailed aspect of the present invention, the final sintered mass can contain less than about one percent by weight non-nanodiamond material. Typically, the final sintered mass can be a nanodiamond PCD that is substantially free of non-carbon materials which are present in typical PCD such as Co, Ni, Fe, and the like. However, the nanodiamond PCD of the present invention may have trace amounts of impurities such as graphitic carbon, minerals, combustion products, and other trace elements.

In an alternative embodiment of the present invention, the assembled mass of nanodiamond particles further includes a carbon source mixed with the nanodiamond particles. The currently preferred carbon source is fullerenes, commonly known as buckyballs, such as C32, C60, C70, C76, C84, C90, C94, C200, and C800, although C60 is the most common fullerene. The mixture of nanodiamond particles and carbon source can be greater than 50% by volume nanodiamond particles, and is preferably from about 55% to about 95% by volume. Upon sintering at high pressures as discussed above, the carbon source is converted to diamond to produce nanocrystalline diamond grown in situ. The final sintered mass is a solid mass having diamond-to-diamond bridges formed among the nanodiamond particles and the in situ grown nanocrystalline diamond. In one aspect of the present invention, the sintered mass consists of carbon.

The nanodiamond particles of the final sintered mass are typically randomly oriented. Unlike standard PCD diamond and CVD diamond film, which typically have oriented diamond particles producing anisotropic properties, the nanodiamond particles of the PCD of the present invention are randomly oriented. This randomness results in physical properties which are isotropic and independent of direction. Further, typical CVD diamond has columnar grains. This columnar grain in CVD is the result of grain growth inherent in CVD deposition. As a result, CVD diamond tends to fracture along these grain boundaries which traverse the entire depth of the deposited CVD. Conversely, the sintered nanodiamond PCD of the present invention does not contain such grain boundaries or cleavage planes. Any cracks which form in the sintered nanodiamond during use will typically be microcracks rather than macrocracks, which increase the useful life of the tool.

Referring again to FIG. 1A, the assembled mass of nanodiamond particles 14 can be overlaid with a layer of at least micron-sized diamond 16 adjacent the mass of nanodiamond particles prior to sintering. In one aspect, the at least micron-sized diamond has an average particle size of from about 0.1 μm to about500 μm. The layer of at least micron-sized diamond 16 includes voids 18. The voids 18 create a network of interstitial spaces throughout the layer. A substrate 20 can then be placed adjacent to the layer of at least micron-sized diamond 16. The substrate 20 can be formed of a material such as, but not limited to, tungsten, titanium, cemented tungsten carbide, cermets, ceramics, and composites or alloys thereof At the temperatures and pressures employed in the present invention, the at least micron-sized diamond typically will not form a coherent mass suitable for mechanical applications without a metal binder or sintering aid such as cobalt, nickel, iron, manganese, or their alloys. As shown in FIG. 1A, the metal binder 22 can be included in the substrate 20. Alternatively, the metal binder can be physically mixed into the micron-sized diamond prior to sintering. Such metal binders can be any conventional infiltrant, sintering aid, carbon solvent, or other metal alloy used in producing coherent micron-sized PCD tools.

Referring now to FIG. 1B, upon sintering, the metal binder 22 melts and flows into the at least micron-sized diamond layer such that the voids 18 are at least partially filled. The molten binder provides additional strength to the at least micron-sized diamond. Depending on the metal binder, the at least micron-sized diamond particles may be bound together by mechanical forces, chemical bonds as in the case of carbide forming metals, or the diamond can be sintered together as in the case of carbon solvent metals such as Co, Fe, Ni, Mn, and their alloys. Notice that in the embodiment depicted in FIG. 1B that the sintered nanodiamond particles 24 will partially fill in spaces between the larger diamonds during formation of the assembly 10 (FIG. 1A) and during sintering to form anchors 26 to improve the strength of the final tool. Additionally, at the interface between the sintered nanodiamond particles 24 and larger diamond 16, the nanodiamond can partially chemically bond to the larger diamond further increasing the strength of the final tool. Further, the metal binder 22 will typically not flow into the nanodiamond mass because of the low porosity leaving very limited flow paths among the interstitial spaces. This is a desirable situation, since the presence of a metal binder in the sintered nanodiamond mass will decrease the stability of the sintered nanodiamond at temperatures above about 700° C. Additionally, the micron-sized diamond can be substituted for any hard abrasive particles such as PCBN, ceramics, and the like. Although such hard particles would not have the same degree of chemical bonding with the nanodiamond layer, these particles can be used advantageously to produce the nanodiamond tools of the present invention.

In an alternative embodiment, the substrate can be bonded to the layer of at least micron-sized diamond subsequent to sintering. In this embodiment, the metal binder can be mixed into the at least micron-sized diamond layer or provided in a layer adjacent to the diamond. The substrate can be bonded to the at least micron-sized diamond layer using any number of known methods such as brazing, gluing, or other known methods.

Although FIG. 1A shows the nanodiamond mass 14 at the bottom of the assembly 10, it will be understood that the assembly can be formed such that the nanodiamond mass is at the top and the substrate is beneath. Those skilled in the art will recognize various configurations, apparatuses, and geometries which can be used in forming such PCD tools.

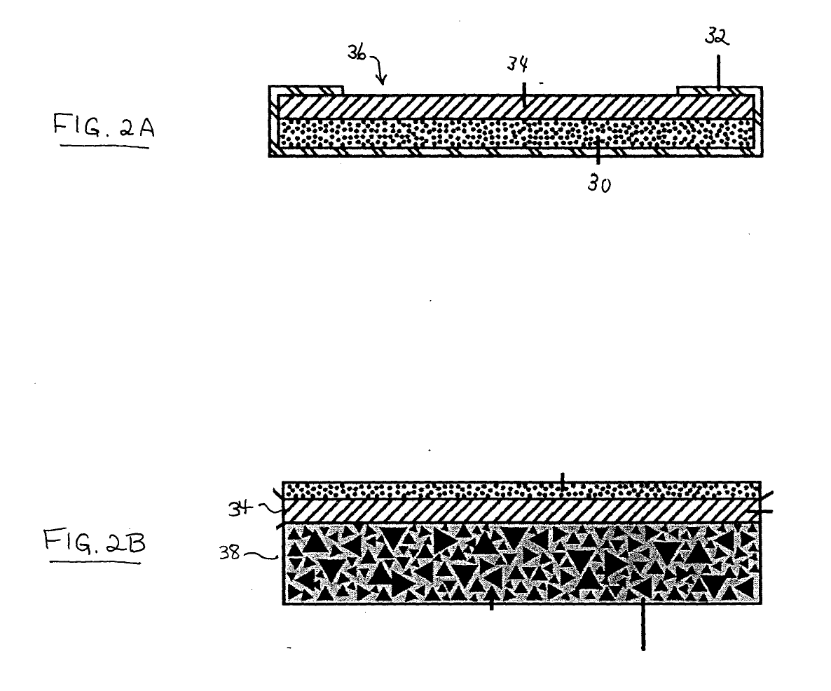

In yet another alternative embodiment, FIG. 2A shows a mass of nanodiamond particles 30 placed in a refractory metal cup 32. A substrate34 can then be placed over the mass of nanodiamond particles to form a tool precursor 36. The tool precursor can then be sintered at conditions such as those described above. Sintering temperatures are typically below standard HPHT processes and can be from about 1,200° C. to about 3,500° C. Pressures can be from about 1 GPa to about 6 GPa. The substrate can be formed from any number of materials such as those listed above. In one aspect, the substrate is a tungsten layer. Tungsten is particularly suited to direct attachment to the nanodiamond layer since the thermal expansion coefficients are much closer than for most other materials, thus avoiding possible peeling and delamination problems. As shown in FIG. 2B, following the high pressure sintering the substrate 34 can be attached to a second substrate 38 such as cemented tungsten carbide, or other cemented carbide, tungsten, titanium, cermets, ceramics, and composites or alloys thereof. The second substrate can be attached to the substrate 34 by brazing or other known methods.

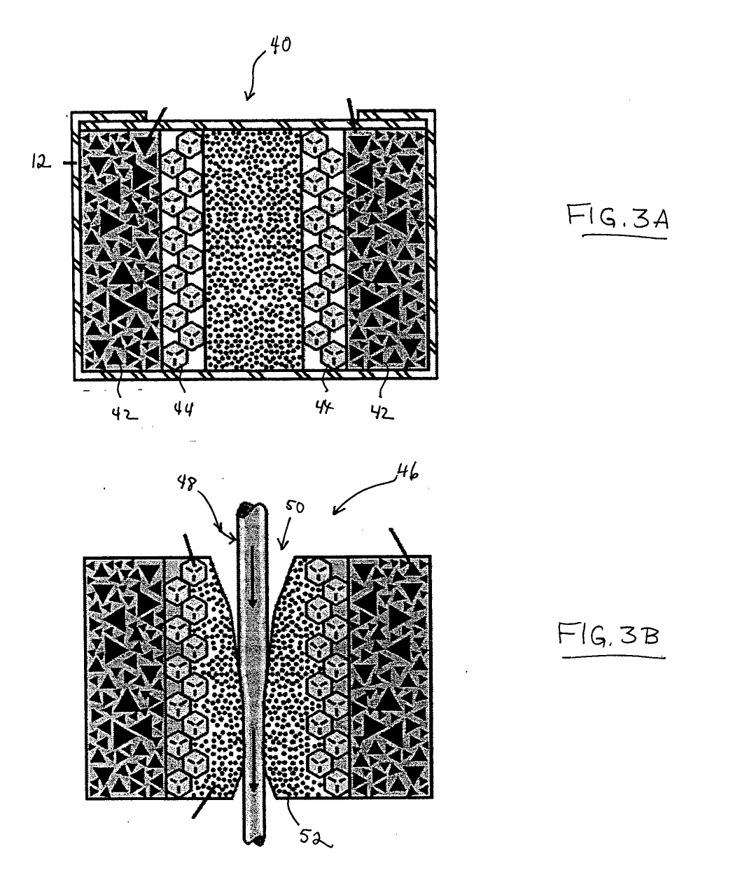

The sintered nanodiamond of the present invention can be utilized in a wide variety of applications. In one aspect, the sintered nanodiamond can be used as an abrasive tool such as, but not limited to, cutting tools, mechanical polishing, wire drawing dies (round or shaped), shaving dies, compacting dies, and the like. FIG. 3A shows a cross-sectional view of a precursor assembly 40 placed inside a refractory metal cup 12 for producing a wire drawing die, shaving die, or the like. The view shown in FIG. 3A is a cross section along the center of the mold. A top view, not shown, would illustrate the layers as concentric cylinders. A substrate 42 can be placed in the mold 12 in a powdered form and/or having a binder included to maintain the shape of the substrate prior to pressing and sintering. A layer of micron-sized diamond 44 can then be placed adjacent the substrate. As with previously described embodiments, this micron-sized diamond layer is optional. The center is then filled with nanodiamond as discussed previously. Of course, the alternative embodiments describing a mixture of nanodiamond and carbon source also apply to the embodiment of FIG. 3A. The precursor 40 is then placed in an HPHT apparatus and exposed at temperatures and pressures as described above for up to about 60 minutes. The sintered tool can then be removed and formed into the desired die tool. FIG. 3B shows a cross-sectional view of a wire drawing die 46, the wire 48 having a circular cross section. The profile of the hole 50 through the center of the die tool can have any number of shapes known to those skilled in the art such as the profile shown. The sintered nanodiamond 52 has increased stability at high temperatures and increased wear time. The die tools of the present invention are suitable for a shaping and production of wires such as, but not limited to, copper, aluminum, stainless steel, tungsten, copper plated steel, and their alloys. In yet another detailed aspect, an insert comprising a non-reactive material such as a ceramic or a high melting point metal can be placed in the center of the mass of nanodiamond particles prior to sintering to facilitate formation of the wire drawing die orifice. Wire drawing dies of the present invention do not contain cobalt or other sintering aids. Typical dies contain cobalt which reacts with many wire materials which causes contamination of the wire and increased force required to pull the wire through the die. In addition, the die surface contains no micron grains and thus the wire will be smoother than traditional PCD wire drawing dies. The higher thermal stability of the present invention, allows for decreased use and even elimination of hazardous lubricants in wire drawing applications.

In still another alternative embodiment, the sintered nanodiamond of the present invention can be used as a heat spreader in electronic devices such as a CPU and other heat producing components. The thermal conductivity of the sintered nanodiamond can approach or even exceed that of natural diamond and can be from about 1,000 W/mK to about 2,500 W/mK. This thermal conductivity exceeds that of most other materials. Typical diamond PCD includes cobalt which lowers the thermal conductivity of such material.

The sintered nanodiamond of the present invention can also be integrated into a surface acoustic wave (SAW) device such as a SAW filter. The sintered nanodiamond can be formed or otherwise attached to a piezoelectric substrate. Diamond is a particularly desirable SAW medium, as the surface acoustic wave velocity is about 11 km/sec, which is higher than most materials. In order to reduce the need for polishing, the sintered nanodiamond can be formed in a refractory metal cup or other surface having an extremely low surface roughness, e.g, less than 10 μm and preferably less than 1 μm. Various attempts have been made to utilize diamond in such devices with limited success. The sintered nanodiamond of the present invention can be incorporated into such devices without some of the difficulties encountered by other methods. Those skilled in the art will recognize the dimensions and additional components, e.g., interdigital transducers, which may be required or desirable in forming various SAW devices.

The sintered nanodiamond of the present invention can also be formed into a radiation window. The radiation window can be transparent to certain wavelengths such as infrared and more translucent to visible wavelengths for example. In some embodiments, the sintered nanodiamond can be transparent. Such transparent sintered nanodiamond can be used as a gemstone which has increased impact resistance over that of natural diamond because of the lack of cleavage planes which traverse the length of the sintered nanodiamond.

The self-sintered nanodiamond of the present invention can be utilized in mechanical or other applications at temperatures up to about 1,000° C. and in some embodiments 1,200° C., although higher temperatures may be tolerated under some conditions, e.g., short time, etc. In one aspect, the nanodiamond tools of the present invention are stable, i.e. maintain their mechanical integrity for extended periods of time, at temperatures up to from about 700° C. to about 1,000° C. The thermal stability of the sintered nanodiamond of the present invention far exceeds that of standard PCD (i.e. less than 700° C.) and is at least that of CVD. Of course, tools incorporating the sintered nanodiamond attached to a micron-sized diamond layer may be used at similar temperatures.

### EXAMPLES

The following examples illustrate various methods of making nanodiamond tools in accordance with the present invention However, it is to be understood that the following are only exemplary or illustrative of the application of the principles of the present invention. Numerous modifications and alternative compositions, methods, and systems can be devised by those skilled in the art without departing from the spirit and scope of the present invention. The appended claims are intended to cover such modifications and arrangements. Thus, while the present invention has been described above with particularity, the following Examples provide further detail in connection with several specific embodiments of the invention.

### Example 1

A layer of nanodiamond having an average particle size of about 5 nm is placed in a tantalum cup to a thickness of about 2 mm. A layer of 40/50 mesh diamond is then placed over the nanodiamond layer to a thickness of 1 mm. A cobalt cemented tungsten carbide substrate measuring about 10 mm in thickness was then placed against the 40/50 mesh diamond layer to form a tool precursor. The assembled tool precursor is then placed in a HTHP apparatus and pressed to about 4 GPa and heated to about 1,800° C. for about 40 minutes. The cobalt infiltrates through the 40/50 mesh diamond layer, but not into the nanodiamond layer. The nanodiamond layer is sintered. The sintered mass is then allowed to cool and removed from the apparatus.

### Example 2

A layer of nanodiamond having an average particle size of about 5 nm is placed in a tantalum cup to a thickness of about 5 mm. A tungsten substrate measuring about 10 mm in thickness was then placed against the nanodiamond layer to form a tool precursor. The assembled tool precursor is then placed in a HTHP apparatus and pressed to about 4 GPa and heated to about 1,600° C. for about 60 minutes. The nanodiamond layer is sintered and then allowed to cool. The sintered product is then removed from the apparatus and brazed to a tungsten carbide substrate using a silver braze.

### Example 3

A mixture of 10% by weight cobalt, 5% by weight organic binder, and 85% by weight tungsten carbide is placed in an annular shape along the inside of a tantalum cup to a thickness of 5 mm. A layer of 40/50 mesh diamond in an organic binder is then layered over the tungsten layer to a thickness of 1 mm. The remaining space is filled with nanodiamond having an average particle size of 100 μm. The assembled tool precursor is then preheated to about 800° C. to remove the organic binder and then placed in a HTHP apparatus and pressed to about 5 GPa and heated to about 2,000° C. for about 45 minutes. The cobalt infiltrates through the 40/50 mesh diamond layer, but not into the nanodiamond layer. The nanodiamond layer is sintered. The sintered mass is then allowed to cool and removed from the apparatus. An aperture is then cut into the nanodiamond section having a profile similar to that shown in FIG. 3B to form a wire drawing die.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A nanodiamond tool, comprising a mass of sintered nanodiamond particles, said mass containing greater than about 95% by volume nanodiamond and greater than about 98% by volume carbon.

2. The nanodiamond tool of claim 1, wherein said nanodiamond particles are self-sintered.

3. The nanodiamond tool of claim 1, said mass further comprising in situ grown nanocrystalline diamond.

4. The nanodiamond tool of claim 3, wherein the in situ grown nanocrystalline diamond is grown from a fullerene carbon source.

5. The nanodiamond tool of claim 1, wherein said mass consists of carbon.

6. The nanodiamond tool of claim 1, wherein the nanodiamond particles have an average diameter of from about 1 nm to about 500 μm.

7. The nanodiamond tool of claim 6, wherein the nanodiamond particles have an average diameter of from about 1 nm to about 100 nm.

8. The nanodiamond tool of claim 7, wherein the nanodiamond particles have an average diameter of from about 2 nm to about 30 nm.

9. The nanodiamond tool of claim 1, wherein the nanodiamond particles have an average crystal size of from about 1 nm to about 20 nm.

10. The nanodiamond tool of claim 1, wherein the nanodiamond particles are randomly oriented.

11. The nanodiamond tool of claim 1, further comprising a substrate attached to the mass of sintered nanodiamond particles.

12. The nanodiamond tool of claim 11, wherein the substrate comprises a layer of at least micron-sized diamond particles bonded together by a metal binder, and a support layer bonded to the layer of at least micron-sized diamond particles.

13. The nanodiamond tool of claim 12, wherein the at least micron-sized diamond particles have an average particle size of from about 0.1 μm to about 100 μm.

14. The nanodiamond tool of claim 12, wherein the metal binder comprises a member selected from the group consisting of nickel, iron, cobalt, manganese, and mixtures or alloys thereof.

15. The nanodiamond tool of claim 11, wherein the substrate comprises a member selected from the group consisting of tungsten, titanium, cemented tungsten carbide, cermets, ceramics, and composites or alloys thereof.

16. The nanodiamond tool of claim 1, wherein said nanodiamond tool is stable at temperatures up to from about 700° C. to about 1,000° C.

17. The nanodiamond tool of claim 1, wherein said nanodiamond tool is a member selected from the group consisting of cutting tools, drill bits, and wire drawing dies.

18. The nanodiamond tool of claim 1, wherein said nanodiamond tool is a heat spreader.

19. The nanodiamond tool of claim 1, wherein said nanodiamond tool is a surface acoustic wave filter.

20. The nanodiamond tool of claim 1, wherein said nanodiamond tool is a radiation window.

21. A method of forming a nanodiamond tool, comprising the steps of:
a) assembling a mass of nanodiamond particles; and
b) sintering the mass of nanodiamond particles to form a sintered mass, said sintered mass containing greater than about 95% by volume nanodiamond particles and greater than about 98% by volume carbon.

22. The method of claim 21, wherein said mass of nanodiamond particles consists essentially of nanodiamond particles up to the step of sintering, such that the sintered mass is self-sintered.

23. The method of claim 21, wherein the step of assembling a mass of nanodiamond particles farther comprises mixing a fullerene carbon source with the nanodiamond particles.

24. The method of claim 21, wherein said sintered mass contains greater than about 99% by volume nanodiamond particles.

25. The method of claim 21, wherein said sintered mass consists of carbon.

26. The method of claim 21, further comprising the step of disposing a first layer of at least micron-sized diamond adjacent the mass of nanodiamond particles prior to sintering.

27. The method of claim 26, wherein the layer of at least micron-sized diamond further comprises a metal binder.

28. The method of claim 27, wherein the metal binder comprises a member selected from the group consisting of nickel, iron, cobalt, manganese, and mixtures or alloys thereof.

29. The method of claim 26, further comprising the step of including a first support material adjacent to the layer of at least micron-sized diamond prior to the step of sintering.

30. The method of claim 29, wherein the first support material comprises a member selected from the group consisting of tungsten, titanium, cemented tungsten carbide, cermets, ceramics, and composites or alloys thereof.
